(19) United States
(12) Patent Application Publication
(10) Pub. No.: US 2024/0280150 A1
(43) Pub. Date: Aug. 22, 2024

(54) Disc Brake for a Commercial Vehicle

(71) Applicant: KNORR-BREMSE Systeme fuer Nutzfahrzeuge GmbH, Muenchen (DE)

(72) Inventors: Sylvain DEROUAULT, Hermival les Vaux (FR); Guillaume LETOT, Caen (FR)

(21) Appl. No.: 18/562,403

(22) PCT Filed: May 20, 2022
(86) PCT No.: PCT/EP2022/063770

§ 371 Date: Nov. 20, 2023

(30) Foreign Application Priority Data
May 27, 2021 (EP) 21176309.9

(51) Int. Cl. F16D 65/00; F16D 55/00; F16D 55/226; F16D 121/04

(52) U.S. Cl. CPC F16D 65/0056; F16D 55/226; F16D 65/0068; F16D 2055/0008; F16D 2121/04; F16D 2250/0084

(57) ABSTRACT

A disc brake for a commercial vehicle includes a pneumatic brake cylinder, a brake disc, a brake caliper, an application device and brake pads. The brake caliper engages over the brake disc and the application device, which can be actuated by the brake cylinder, is arranged in the brake caliper, by which the brake pads can be pressed against the brake disc on both sides during braking. An extendable and retractable piston rod of the brake cylinder is in engagement with the brake application device and the brake caliper is detachably fastened to the brake cylinder by a fastening device. The fastening device includes at least one screw with a screw head, a screw shank and an external thread formed on the screw shank and at least one bore formed in or on the brake cylinder with an internal thread, into which the screw shank is screwed with the external thread, wherein the screw head is locked on a counter surface of the brake caliper.

### BACKGROUND AND SUMMARY

The invention relates to a disc brake for a commercial vehicle with a pneumatic brake cylinder, a brake disc, a brake caliper, a brake application device and with brake pads, wherein the brake caliper engages over the brake disc and the brake application device, which can be actuated by the brake cylinder and by means of which the brake pads can be pressed against the brake disc on both sides during braking, is arranged in the brake caliper, wherein a retractable and extendable piston rod of the brake cylinder is in engagement with the brake application device and the brake caliper is detachably fastened to the brake cylinder by means of a fastening device.

The invention further relates to a commercial vehicle with at least one such disc brake and to a method for detaching the brake cylinder from the brake caliper of the disc brake.

A generic disc brake is known from DE 10 2012 016 712 A1. The fastening device there has bolts provided with an external thread, which are fastened in the brake cylinder, project away from the brake cylinder and into screw eyes of the brake caliper, where they are locked by means of nuts. The disadvantage of this type of fastening device is that when the brake cylinder is detached from the brake caliper, for example for repair purposes, the brake cylinder must be pulled away from the brake caliper in the direction of the bolts, at least over the length of the bolts, so that the bolts of the brake cylinder can be pulled out of the bolt eyes of the brake caliper. However, this requires a certain amount of space within the wheel housing of the commercial vehicle in which the disc brake is located, which is often not available. Furthermore, the disassembly of the brake cylinder from the brake caliper then is time consuming.

It is therefore the object of this invention to provide a disc brake for a commercial vehicle which is easier to install and remove. Furthermore, a vehicle with such a disc brake as well as a method for detaching the brake cylinder of the disc brake from the brake caliper of the disc brake are to be provided.

This object is solved according to the invention by the features of the independent claims.

The invention is based on a disc brake for a commercial vehicle with a brake cylinder, a brake disc, a brake caliper, a brake application device and with brake pads, wherein the brake caliper engages over the brake disc, and the brake application device, which can be actuated by the brake cylinder, is arranged in the brake caliper, by means of which the brake pads can be pressed against the brake disc on both sides during braking, and an extendable and retractable piston rod of the brake cylinder being in engagement with the brake application device, and the brake caliper being detachably fastened to the brake cylinder by means of a fastening device.

The retractable piston rod of the brake cylinder engages with the brake application device, for example, in that the brake application device has a receptacle for one end of the piston rod, in which this end engages.

The brake caliper is detachably attached to the brake cylinder by means of a fastening device, meaning that the brake caliper and the brake cylinder can be dismantled from each other without destroying them by loosening the fastening device.

According to the invention, it is then provided that the fastening device comprises at least one screw with a screw head, a screw shank and an external thread formed on the screw shank, and at least one bore formed in or on the brake cylinder with an internal thread, into which the screw shank with the external thread is screwed, the screw head being locked on a counter surface of the brake caliper. The counter surface can be formed, for example, by an edge of a screw eye on the brake caliper.

The screw head of the at least one screw therefore points towards the brake caliper and is locked there in a through hole, in particular in a screw eye, while the screw shank points towards the brake cylinder and is screwed there in the bore.

A screw connection is therefore provided between the brake caliper and the brake cylinder, whereby, in contrast to DE 10 2012 016 712 A1 mentioned at the beginning, the conditions are reversed and the brake cylinder is not provided with at least one protruding bolt, but with at least one bore into which a screw is screwed with its screw head countered, for example, at the at the edge of a screw eye or a through bore of the brake caliper. This means that the brake cylinder does not have to be removed any further from the brake caliper than is necessary to disengage the piston rod of the brake cylinder from the brake application device of the caliper. This advantageously reduces the space required for disassembly within the wheel housing of the commercial vehicle.

The bore can be formed in a wall of the brake cylinder or in a separate body which is detachably or non-detachably connected to the wall of the brake cylinder.

Also, the separate body may be located inside the brake cylinder and the screw shank may extend through a through hole in the wall of the brake cylinder and be screwed into the bore in the body.

In particular, the body can be welded to the wall of the brake cylinder.

A ring washer can also be arranged between the screw head and the counter surface, which enables the screw connection to be set.

According to a further embodiment, the brake caliper can have a recess in the area of the screw head in such a way that, seen in a direction perpendicular to a screw axis of the screw, a screwdriving tool can be applied to the screw head and then the screw can be screwed by means of the screwdriving tool. The screw head can have any attachment surface for the screwdriving tool, for example an outer polygonal profile, in particular an outer hexagonal profile for an open-end spanner, or an inner polygonal profile, for example for an Allen key.

Preferably, the at least one screw and the piston rod of the brake cylinder are also arranged parallel to each other.

According to a further embodiment, the pneumatic brake cylinder can be a part of a combined pneumatic service and spring brake cylinder or a separate pneumatic service brake cylinder. In both cases, the piston rod can then be a service brake piston rod of the service brake cylinder.

The method according to the invention for detaching the brake cylinder from the brake caliper of the disc brake then comprises at least the following steps:
a) Attaching a screwdriving tool to the screw head,
b) Unscrewing at least one screw from the bore,
c) Removing at least one screw,
d) Disengaging the piston rod of the brake cylinder from the brake application device in the brake caliper.

For a disassembly or the detaching of the brake cylinder from the brake caliper, after loosening and removing the at least one screw, the brake cylinder therefore only has to be removed from the brake caliper as seen in particular in the direction of a longitudinal axis of the at least one screw until the piston rod of the brake cylinder is out of engagement with the brake application device in the brake caliper.

The invention also includes a commercial vehicle having at least one disc brake described above.

An embodiment of the invention is shown below in the drawings and explained in more detail in the following description.

### BRIEF DESCRIPTION OF THE DRAWINGS

FIG. 1 is a perspective partial sectional view of a disc brake according to a preferred embodiment with a pneumatic brake cylinder attached to a brake caliper by way of a detachable fastening device;

FIG. 2 is an enlarged section of FIG. 1 showing the fastening device;

FIG. 3 is a perspective interior view of the brake cylinder of the disc brake of FIG. 1;

FIG. 4 is an enlarged section of the interior view of FIG. 3;

FIG. 5 is a side view of the disc brake of FIG. 1 in an assembled state; and

FIG. 6 is a side view of the disc brake of FIG. 1 in a state during disassembly of the brake cylinder from the brake caliper.

### DETAILED DESCRIPTION OF THE DRAWINGS

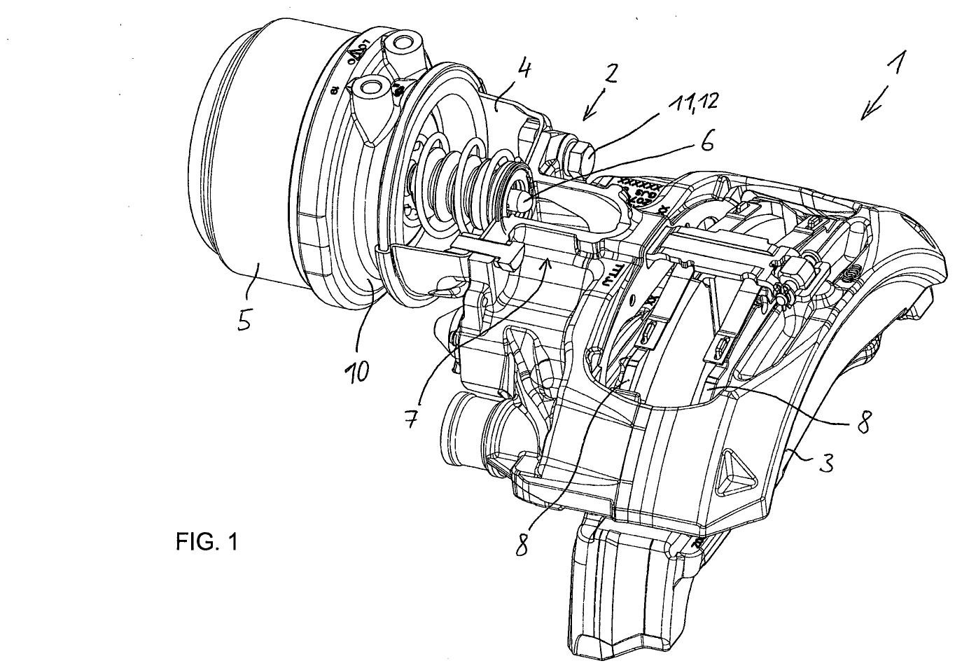

FIG. 1 shows a perspective partial sectional view of a disc brake 1 of a commercial vehicle according to a preferred embodiment, with a pneumatic brake cylinder 4 detachably fastened to a brake caliper 3 via a detachable fastening device 2. The pneumatic brake cylinder 4 is here, for example, a pneumatic service brake cylinder which forms a structural unit with a spring brake cylinder 5, which then represents a so-called combination cylinder of pneumatic service brake cylinder 4 and pneumatic spring brake cylinder 5.

The disc brake 1 comprises the pneumatic service brake cylinder 4, a brake disc (not shown here), the brake caliper 3 which engages over the brake disc, and a brake application device 7 (not shown in detail here), which is arranged in the brake caliper 3 and can be actuated by a piston rod 6 of the service brake cylinder 4, as well as brake pads 8.

More precisely, the piston rod 6 is connected to a brake piston 9 of the service brake cylinder 4, which is actuated by venting and deaeration of a brake chamber 10 of the service brake cylinder 4, wherein the piston rod 6 moves out of the service brake cylinder 4 during venting and moves into the service brake cylinder 4 during deaeration, for example. One end of the piston rod 6 engages with a receptacle of the brake application device 7 in such a way that the retraction or extension movement of the piston rod 6 is transmitted to a mechanism of the brake application device 7, whereupon the latter presses the brake pads 8 against the brake disc on both sides when the brake is applied (ventilation of the brake chamber 10) and releases them from the brake disc when the brake is released (deaeration of the brake chamber 10).

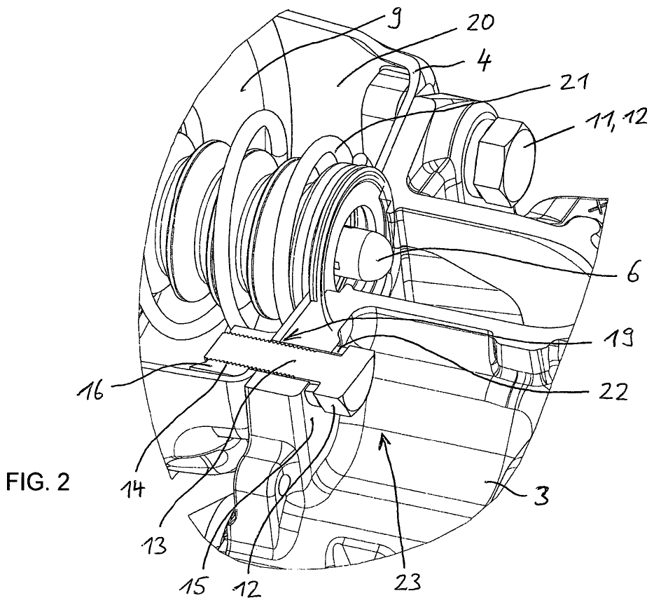

The fastening device 2, by means of which the brake caliper 3 and the service brake cylinder 4 can be mounted or released from one another, comprises several screw connections. Such a screw connection comprises a screw 11 with a screw head 12, a screw shank 13 and an external thread formed on the screw shank 13 and at least one bore 14 formed here, for example, in the service brake cylinder 4 with an internal thread, into which the screw shank 13 with the external thread is screwed, as is visible in particular in FIG. 2. The screw head 12 is locked on a counter surface 15 of the brake caliper 3, which is formed here for example by an edge of a screw eye of the brake caliper 3. Preferably, the screws 11 of the screw connections and the piston rod 6 of the service brake cylinder 4 are arranged parallel to each other.

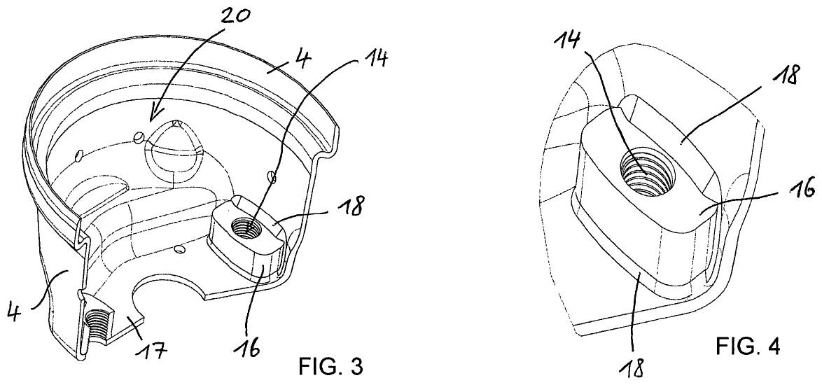

The bore 14 is formed here, for example, as a blind bore or through bore in a body 16, which is arranged here, for example, separately, inside the service brake cylinder 4, as FIG. 3 shows, and is welded in particular to a wall 17 of the service brake cylinder 4 here, for example, by means of a circumferential weld seam 18, as FIG. 4 shows. The bore 14 is then provided on its radially inner circumferential surface with the internal thread into which the external thread of the screw 11 is screwed. The body 16 is, for example, cuboid-shaped, with at least one of its outer surfaces being designed to fit snugly against the inner surface of the wall 17 of the service brake cylinder 4.

The screw shank 13 of the screw 11 extends through a through hole 19 in the wall 17 of the brake cylinder 4 to be screwed to the hole 14 of the body 16. In particular, the body 16 is arranged in a spring chamber 20 separated from the brake chamber 10 by the brake piston 9, which is in communication with the atmosphere and in which is housed a piston spring 21 biasing the brake piston 9 to the released position. In this respect, this spring chamber 20 does not have to be pressure-tight. Also, an annular washer 22 is arranged here between the screw head 12 and the counter surface 15, here for example in the form of the edge of the screw eye.

As best shown in FIG. 2, the brake caliper 3 can have a recess 23 in the area of the screw head 12 or in the area of the counter surface 15 (e.g. the screw eye) in such a way that, viewed in a direction perpendicular to a screw axis of the screw 11, a screwdriving tool can be applied to the screw head 12 and then the screw 11 can be screwed by means of the screwdriving tool. For this purpose, the screw head 12 can have any attachment surface for the screwdriving tool, in this case, for example, an outer hexagonal profile for an open-end spanner. By applying the open-end spanner to the hexagonal profile of the screw head 12, the screw connection can therefore be assembled or loosened. Preferably, the fastening device comprises several such screw connections, in particular arranged distributed over the circumference of the service brake cylinder 4.

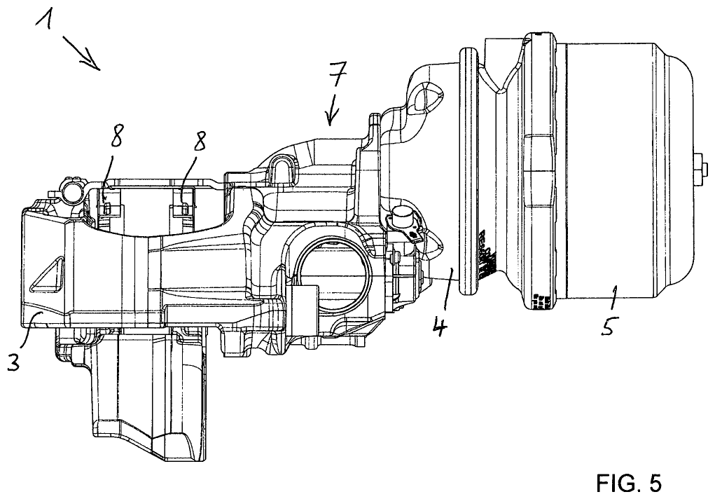

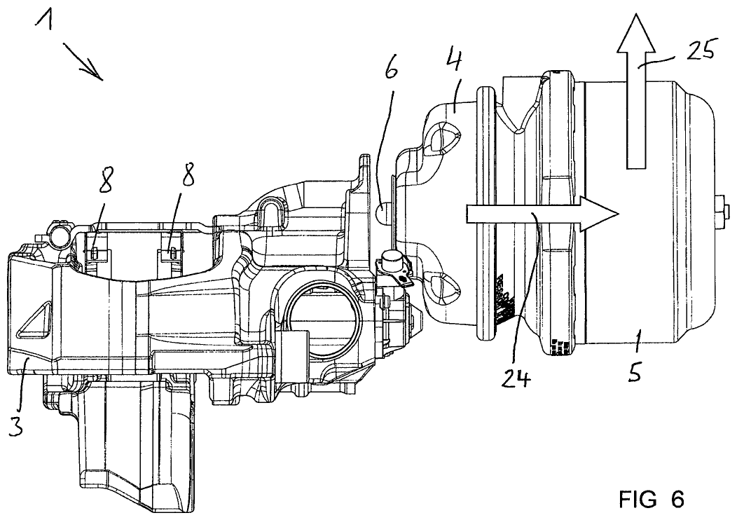

Therefore, starting from the mounted state of the service brake cylinder 4 on the brake caliper 3 of the disc brake 1 shown in FIG. 5, in order to detach the service brake cylinder 4 from the brake caliper 3, for example, the open-end spanner is applied to the hexagonal profiles of the bolt heads 12 and then the bolts 11 are unscrewed from the bores 14 of the bodies 16 or of the service brake cylinder 4 and then removed. Further, the end of the piston rod 6 of the service brake cylinder 4 is disengaged from the associated receptacle of the brake application device 7 in the brake caliper 3 by pulling the service brake cylinder 4 off the brake caliper 3 a short distance in the first direction indicated by the first arrow 24 in FIG. 6, this first direction preferably being parallel to the piston rod 6. When the end of the piston rod 6 is then out of engagement with the associated receptacle of the brake application device 7, the service brake cylinder 4, which has been released from the brake caliper 3, is removed from the brake caliper 3 in a second direction indicated by the second arrow 25 in FIG. 6, which is preferably perpendicular to the first direction, and can then be pulled out of the wheel housing transversely, for example.

For a disassembly of the service brake cylinder 4 from the brake caliper 3, after loosening and removing the screws 11, the service brake cylinder 4 must therefore only be removed from the brake caliper 3, in particular as seen in the direction of the longitudinal axes of the screws 11, until the end of the piston rod 6 of the service brake cylinder 4 is out of engagement with the associated receptacle of the brake application device 7 in the brake caliper 3.

### LIST OF REFERENCE SIGNS

1 Disc brake
2 Fastening device
3 Brake caliper
4 Service brake cylinder
5 Spring brake cylinder
6 Piston rod
7 Brake application device
8 Brake pads
9 Brake piston
10 Braking chamber
11 Screw
12 Screw head
13 Screw shaft
14 Bore
15 Counter surface
16 Body
17 Wall
18 Weld
19 Through hole
20 Spring chamber
21 Piston spring
22 Recess
24 First arrow
25 Second arrow

1.-11. (canceled)

12. A commercial vehicle disc brake for use with a brake disc, comprising:
a pneumatic brake cylinder having an extendable and retractable piston rod;
a brake caliper;
a brake application device; and
a fastening device,
wherein the brake caliper engages over the brake disc in use, and the brake application device, which is actuatable by the brake cylinder, is arranged in the brake caliper, and by which brake pads are pressable against the brake disc on both sides during braking;
wherein the extendable and retractable piston rod of the brake cylinder is in engagement with the brake application device,
the brake caliper is detachably fastened to the brake cylinder via the fastening device, and
the fastening device comprises at least one screw with a screw head, a screw shank and an external thread formed on the screw shank, and at least one bore formed in or on the brake cylinder with an internal thread, into which the screw shank is screwed with the external thread, the screw head being locked on a counter surface of the brake caliper.

13. The disc brake according to claim 12, wherein
the bore is formed in a wall of the brake cylinder, or in a separate body which is detachably or non-detachably connected to the wall of the brake cylinder.

14. The disc brake according to claim 13, wherein
the separate body is arranged inside the brake cylinder and the screw shank extends through a through bore in the wall of the brake cylinder and is screwed into the bore of the body.

15. The disc brake according to claim 13, wherein the separate body is welded to the wall of the brake cylinder.

16. The disc brake according to claim 12, further comprising an annular washer arranged between the screw head and the counter surface.

17. The disc brake according to claim 12, wherein the counter surface comprises a screw eye.

18. The disc brake according to claim 12, wherein
the brake caliper has a recess in a region of the screw head such that, viewed in a direction perpendicular to a screw axis of the screw, a screwing tool can be applied to the screw head so that the screw is screwable by use of the screwing tool.

19. The disc brake according to claim 12, wherein
the at least one screw and the piston rod are arranged parallel to each other.

20. The disc brake according to claim 12, wherein the pneumatic brake cylinder is:
a) part of a combined service and spring brake cylinder, or
b) a separate service brake cylinder.

21. A method for detaching a brake cylinder having an extendable and retractable piston rod from a brake caliper of a disc brake comprising:
a brake caliper;
a brake application device; and
a fastening device,
wherein the brake caliper engages over the brake disc in use, and the brake application device, which is actuatable by the brake cylinder, is arranged in the brake caliper, and by which brake pads are pressable against the brake disc on both sides during braking;
wherein the extendable and retractable piston rod of the brake cylinder is in engagement with the brake application device,
the brake caliper is detachably fastened to the brake cylinder via the fastening device, and
the fastening device comprises at least one screw with a screw head, a screw shank and an external thread formed on the screw shank, and at least one bore formed in or on the brake cylinder with an internal thread, into which the screw shank is screwed with the external thread, the screw head being locked on a counter surface of the brake caliper,
the method comprising:
a) attaching a screwdriver to the screw head;
b) unscrewing the at least one screw from the bore in or on the brake cylinder;
c) removing the at least one screw; and
d) disengaging the piston rod of the brake cylinder from the brake application device in the brake caliper.

22. A commercial vehicle comprising at least one disc brake according to claim 12.
